(19) United States
(12) Patent Application Publication
(10) Pub. No.: US 2015/0058788 A1
(43) Pub. Date: Feb. 26, 2015

(54) INFORMATION PROCESSING METHOD AND ELECTRONIC DEVICE

(71) Applicants: Lenovo (Beijing) Co., Ltd., Beijing (CN); Beijing Lenovo Software Ltd., Beijing (CN)

(72) Inventor: Longfei Liu, Beijing (CN)

(73) Assignees: Lenovo (Beijing) Co., Ltd., Beijing (CN); Beijing Lenovo Software Ltd., Beijing (CN)

(21) Appl. No.: 14/229,407

(22) Filed: Mar. 28, 2014

(30) Foreign Application Priority Data
Aug. 26, 2013 (CN) 201310376988.7

(51) Int. Cl. G06F 3/0484; G06F 3/0481

(52) U.S. Cl. CPC G06F 3/0484; G06F 3/04817
USPC 715/781

(57) ABSTRACT

The present invention discloses an information processing method and an electronic device, the method being applicable to an electronic device capable of executing a first application, and the method including: detecting at an instance of time T1 whether there is a first predetermined operation, wherein the first predetermined operation is configured to control the electronic device to present a second interface for displaying a set of second applications satisfying a predetermined condition; determining whether the set of second applications includes the first application; and when it is determined that the set of second applications includes the first application, displaying the first application via a third interface in the second interface, wherein the difference between the third interface and a first interface is greater than or equal to a first threshold.

The present application claims the priority of Chinese Patent Application No. 201310376988.7, entitled as “Information processing method and electronic device”, and filed with the Chinese Patent Office on Aug. 26, 2013, the contents of which are incorporated herein by reference in its entirety.

### FIELD OF THE INVENTION

The present invention relates to the field of electronics technology and in particular to an information processing method and an electronic device.

### BACKGROUND OF THE INVENTION

Along with the development of electronics technology, smart electronic devices become increasingly popular, they have been provided with standalone operating systems and can be installed by a user with her or his applications and those applications provided by a third-party game service provider, and functions of the electronic devices can be augmented constantly by such applications.

In the convention, after an application is operated, data contents related to the access of the application may be stored, for example, a lastly accessed interface of the application and data lastly received by the application, and the application can be made to be operated in the background. Each application has stored its data contents related to an access thereto, and when the application exists abnormally, for example, there is an exit from an interface of the application based upon the HOME key or the HOME key is directly pressed for long, last statuses of accesses to all of recently opened applications may be displayed in an interface of a lastly opened application, and the user has to clear them manually.

Taking a smart phone as an example, the Home key of the smart phone is pressed for long while an application is being executed, and an operating system invokes the stop( ) method of Activity at the top in a stack of applications to thereby hide the entire application, and when the application of the smart phone is clicked on again and entered, the operating system invokes the “OnResume( )” method of “Activity” at the top, and at this time the application will be entered directly instead of being opened again. “Activity” at the top in the stack of application will be presented directly. The active status upon last exit based upon the HOME key will be maintained.

However, the inventor of this application have identified during implementing the technical solution in embodiments of the invention at least the following technical problem in the convention:

Since last access statuses will be displayed in an interface of the last application when an application exists abnormally in the convention, the application with private data may be revealed in some interface in the existing technical solution, for example, QQ chat information, lastly browsed contents of a browser, an image lastly acquired by a camera, etc., so the existing technical solution may suffer from the technical problem of poor information confidentiality so that the privacy of the user may tend to be revealed.

### SUMMARY OF THE INVENTION

Embodiments of this application provide an information processing method and an electronic device so as to address the technical problem in the convention of poor information confidentiality and achieve a technical effect of preventing a last access status of an application from being revealed.

In an aspect, an embodiment of this application provides an information processing method, applicable to an electronic device capable of executing a first application, the method including:

detecting at an instance of time T1 whether there is a first predetermined operation, wherein the first predetermined operation is configured to control the electronic device to present a second interface for displaying a set of second applications satisfying a predetermined condition;

determining whether the set of second applications includes the first application; and

when it is determined that the set of second applications includes the first application, displaying the first application via a third interface in the second interface, wherein the difference between the third interface and a first interface is greater than or equal to a first threshold so that a user can not identify display contents of the first interface via the third interface, and the first interface is a display interface of the first application at the instance of time T1.

Optionally, detecting whether there is a first predetermined operation further includes:

detecting whether there is a press operation pressing the “HOME” key for more than a predetermined length of time.

Optionally, the set of second applications includes:

a set of applications operating in the electronic device; or

a set of applications which have been executed by the electronic device in a recent period of time of a predetermined length of time.

Optionally, before the detecting at an instance of time T1 whether there is a first predetermined operation, the method further includes:

detecting a setting operation by the user; and

setting the first application as a private application in response to the setting operation so that a list of private applications includes the first application

Optionally, when the third interface is a first application icon corresponding to the first application, displaying the first application via the third interface in the second interface further includes:

obtaining the first application icon; and

displaying the first application icon in the second interface to display the first application.

Optionally, displaying the first application via the third interface in the second interface further includes:

performing image processing in a predetermined form on the first interface to form an identification interface via which the user can not view the display contents; and

presenting the identification interface in the second interface to display the first application.

Optionally, performing image processing in a predetermined form on the first interface further includes:

obscuring the first interface to obscure the display contents; or

adding an overlying layer on the first interface to cover the display contents.

In an aspect, an embodiment of this application provides an electronic device capable of executing a first application, the electronic device including:

a first detection unit configured to detect at an instance of time T1 whether there is a first predetermined operation, wherein the first predetermined operation is configured to control the electronic device to present a second interface for displaying a set of second applications satisfying a predetermined condition;

a determination unit configured to determine whether the set of second applications includes the first application; and

a presentation unit configured, when it is determined that the set of second applications includes the first application, to display the first application via a third interface in the second interface, wherein the difference between the third interface and a first interface is greater than or equal to a first threshold so that a user can not identify display contents of the first interface via the third interface, and the first interface is a display interface of the first application at the instance of time T1.

Optionally, the first detection unit further includes:

a press detection sub-unit configured to detect whether there is a press operation pressing the “HOME” key for more than a predetermined length of time.

Optionally, the electronic device further includes:

a second detection unit is configured to detect a setting operation by the user; and

a setting unit configured to set the first application as a private application in response to the setting operation so that a list of private applications includes the first application.

Optionally, when the third interface is a first application icon corresponding to the first application, the presentation unit further includes:

an obtainment sub-unit configured to obtain the first application icon; and

a first display sub-unit configured to display the first application icon in the second interface to display the first application.

Optionally, the presentation unit further includes:

an image processing sub-unit configured to perform image processing in a predetermined form on the first interface to form an identification interface via which the user can not view the display contents; and

a second display sub-unit configured to present the identification interface in the second interface to display the first application.

Optionally, the image processing sub-unit is further configured:

to obscure the first interface to obscure the display contents; or

to add an overlying layer on the first interface to cover the display contents.

One or more of the technical solutions according to the embodiments of this application have at least the following technical effects and advantages:

1. Upon detection of a first predetermined operation configured to control the electronic device to present a second interface, it is determined whether the set of second applications includes a first application, where the second interface is configured to display the set of second applications satisfying a predetermined condition; and when the set of second applications includes the first application, the first application is displayed via a third interface in the second interface, where the difference between the third interface and a first interface is greater than or equal to a first threshold, and with such a technical solution, the first application can be displayed via the third interface to thereby prevent the first interface at the instance of time T1 from being revealed so that a user can not identify display contents of the first interface via the third interface, thus addressing the technical problem in the convention of poor information confidentiality and further achieving a technical effect of preventing a last access status of an application from being revealed and thus improving information confidentiality.

2. Furthermore, a setting operation by the user is detected before it is detected at the instance of time T1 whether there is a first predetermined operation; and in response to the setting operation, the first application is set as a private application so that a list of private applications includes the first application, and with such a technical solution, the application for which privacy needs to be protected can be displayed via the third interface, and an application for which no privacy needs to be protected can be displayed via the first interface, thereby achieving a technical effect of controlling flexibly the number and types of applications for which it is to be determined whether to output last access statuses.

3. Furthermore, the first application, for example, the first application icon corresponding to the first application, is displayed via the third interface with a difference thereof from the first interface being above the first threshold, or the first interface is image-processed and is then output, so the user can not view the last access status of the first application, thereby achieving convenient and rapid protection of private data.

### BRIEF DESCRIPTION OF THE DRAWINGS

FIG. 1 is a flow chart of an information processing method according to an embodiment of the application;

FIG. 2 is a schematic diagram of setting a first application as a private application according to an embodiment of the application;

FIG. 3 is a display effect diagram of a second interface according to an embodiment of the application; and

FIG. 4 is a diagram of modules of an electronic device according to an embodiment of the application.

### DETAILED DESCRIPTION OF THE INVENTION

In the invention, embodiments of this application provide an information processing method and an electronic device so as to address the technical problem in the convention of poor information confidentiality and achieve a technical effect of preventing a last access status of an application from being revealed.

In order to address the foregoing problem of poor information confidentiality, a general idea of a technical solution according to the embodiments of this application is as follows:

It is detected at an instance of time T1 whether there is a first predetermined operation, where the first predetermined operation is configured to control the electronic device to present a second interface for displaying a set of second applications satisfying a predetermined condition; it is determined whether the set of second applications includes the first application; and when it is determined that the set of second applications includes the first application, the first application is displayed via a third interface in the second interface, where the difference between the third interface and a first interface is greater than or equal to a first threshold so that a user can not identify display contents of the first interface via the third interface, and the first interface is a display interface of the first application at the instance of time T1.

With the foregoing solution, when the first application is an application for which privacy needs to be protected, the first application will not be displayed via the first interface in which display contents of a last access status of the first application are displayed, but instead the first application will be displayed via the third interface with a difference thereof from the first display being above the first threshold, so the user can not identify the display contents of the first interface, and private data of the user can be protected, thereby addressing the technical problem in the convention of poor information confidentiality and further achieving a technical effect of preventing a last access status of an application from being revealed and thus improving information confidentiality.

The technical solution of the invention will be detailed below with reference to the drawings and particular embodiments thereof, and it shall be appreciated that the embodiments of the invention and particular features in the embodiments are intended to serve a detailed description of but not to limit the technical solution of the invention, and the embodiments of the invention and particular features in the embodiments can be combined with each other unless there is any collision.

In an aspect of the invention, an embodiment of this application provides an information processing method, applicable to an electronic device, which can be particularly a smart phone, a tablet computer, a notebook computer, etc., and which is capable of executing a first application.

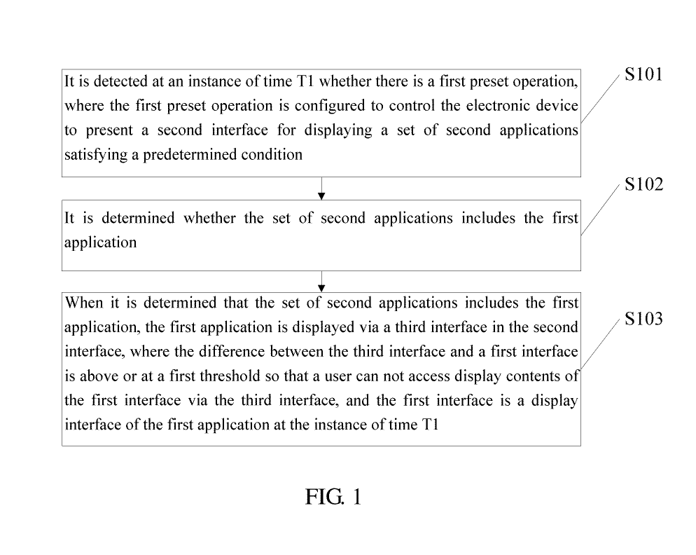

As illustrated in FIG. 1, the method includes the following steps:

S101: It is detected at an instance of time T1 whether there is a first predetermined operation, where the first predetermined operation is configured to control the electronic device to present a second interface for displaying a set of second applications satisfying a predetermined condition;

S102: It is determined whether the set of second applications includes the first application; and

S103: When it is determined that the set of second applications includes the first application, the first application is displayed via a third interface in the second interface, where the difference between the third interface and a first interface is greater than or equal to a first threshold so that a user can not identify display contents of the first interface via the third interface, and the first interface is a display interface of the first application at the instance of time T1.

In a particular implementation, in order to set flexibly the number and types of applications for which it is to be determined whether to output last access statuses, before the step S101, the method further includes the steps of detecting a setting operation by the user; and setting the first application as a private application in response to the setting operation so that a list of private applications includes the first application.

Specifically an option “Application Privacy Setting” is added to security operations of the electronic device, and this setting option is configured to obtain a list of all the applications installed on the smart phone, and the user sets all the applications in the list so that all the applications are set with different privacy levels as desirable to the user, for example, the QQ application, a gallery application, an email application, a browser application and other applications are set as private applications, where the first application may be the QQ application, the gallery application, the email application, the browser application, etc., and a map application, a clock application, a weather application and other applications are set as non-private applications. In a specific application, a privacy level of the application can be altered in response to an alteration operation by the user upon detection of the alteration operation on the privacy level of the first application.

After the first application is set as a private application, the flows next proceeds to the step S101 where it is detected at the instance of time T1 whether there is a predetermined operation.

Where the first predetermined operation is configured to control the electronic device to present the second interface in which the set of second applications satisfying the predetermined condition is displayed. When the electronic device is a smart phone, the first predetermined operation can be a long-press operation on the “HOME” key, and then the smart phone detects whether the long-press operation presses the “HOME” key for more than a predetermined length of time.

After the step S101, the flow next proceeds to the step S102 where it is determined whether the set of second applications includes the first application.

In a particular implementation, the set of second application can be a set of applications operating in the electronic devices or can be a set of applications which have been executed by the electronic device in a recent period of time of a predetermined length of time, for example, a set of applications which have been executed in one day, a set of applications which have been executed in one week, etc.

Specifically it is determined whether the set of second applications includes the first application particularly by determining whether the set of operating applications includes a private application, e.g., the QQ application, a gallery application, the email application, the browser application, etc.

After the step S102 is performed, the flow proceeds to the step S103 where when it is determined that the set of second applications includes the first application, the first application is displayed via the third interface in the second application.

In a particular implementation, the first interface is a display interface of the first application at the instance of time T1. The step S103 will be exemplified below by way of an example where an application currently accessed in the electronic device is a camera application and the set of second applications is a set of operating applications.

For example, at the instance of time T1 in the camera application, a camera is ready to take a picture of the landscape scene “East Apex of Mountain Hua”, and then the electronic device detects whether there is a press operation on the “HOME” key to satisfy a predetermined length of time, and when there is a press operation on the “HOME” key at the instance of time T1 to satisfy the predetermined length of time, it is determined whether the camera application is a private application, and when the camera application is a private application, which indicates that the set of second applications includes the first application, then the second interface is presented as a set of operating applications interface, and the camera application is displayed via the third interface in the set of operating applications interface; and the user can not view the landscape scene “East Apex of Mountain Hua” via the third interface in the set of operating applications interface. On the contrary, when the camera application is not a private application, the second interface is presented as an operating interface, and the camera application is displayed via the first interface in the operating interface so that the user can view the “East Apex of Mountain Hua” in the first interface.

In a particular implementation, the difference between the third interface and the first interface is greater than or equal to the first threshold so that the user can not identify display contents of the first interface via the third interface, and specifically the first interface is an interface of the first application at the instance of time T1, and then the third interface can be a first application icon corresponding to the first application or can be a third interface generated as a result of performing image processing on the first interface.

In a first implementation, when the third interface is a first application icon, the first application icon is obtained; and the first application icon is displayed in the second interface to display the first application.

Specifically, the first application icon corresponding to the first application is stored in a memory stack, the second interface is associated with the first application icon corresponding to the first application, and when the second interface is presented, a first application identifier of the first application is obtained to indicate that the first application is operating or has recently operated. Thus information about the last access status of the first application can be hidden, but the first application can be entered based upon the first application identifier in the second interface.

In a second implementation, firstly image processing in a predetermined form is performed on the first interface to form an identification interface via which the user can not view the display contents; and then the identification interface is presented in the second interface to display the first application.

Specifically image processing in the predetermined form can be obscuring processing on the first interface to obscure the display contents of the first interface or can be the addition of an overlying layer on the first interface, for example, the addition of a black layer on the first interface to cover the display contents on the first interface.

It is assumed that a smart phone A of a user, Ms. or Mr. Wang is installed with a QQ application, a camera application, a clock application, a dialing application and a short messaging application. The user, Ms. or Mr. Wang, needs to have the QQ application, the camera application and the short messaging application protected for privacy so as to prevent her or his privacy from being revealed.

With the foregoing assumption as an example, the technical solution according to the embodiment of the invention will be exemplified with reference to FIG. 1 to FIG. 3, but the invention will not be limited thereto.

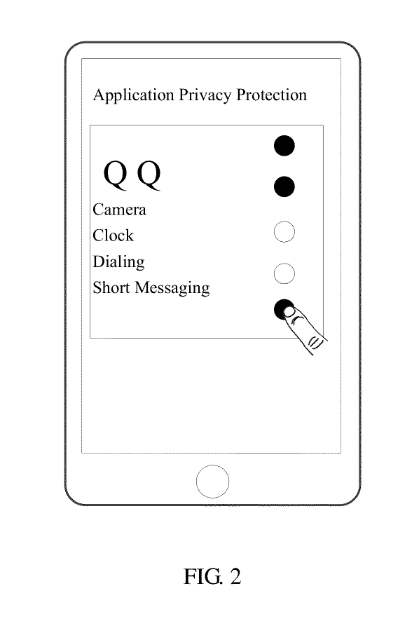

Referring to FIG. 2, firstly a setting option “Security and Privacy” of the smart phone A is entered, and “Application Privacy Protection” is selected so that a list of all the installed applications is displayed on the smart phone A, and Ms. or Mr. Wang selects the QQ, camera and short messaging applications. Then on the smart phone A, the QQ application, the camera application and the short messaging application are set as private applications, and the clock application and the dialing application which are not selected are set as non-private applications, and such setting by Ms. or Mr. Wang is stored.

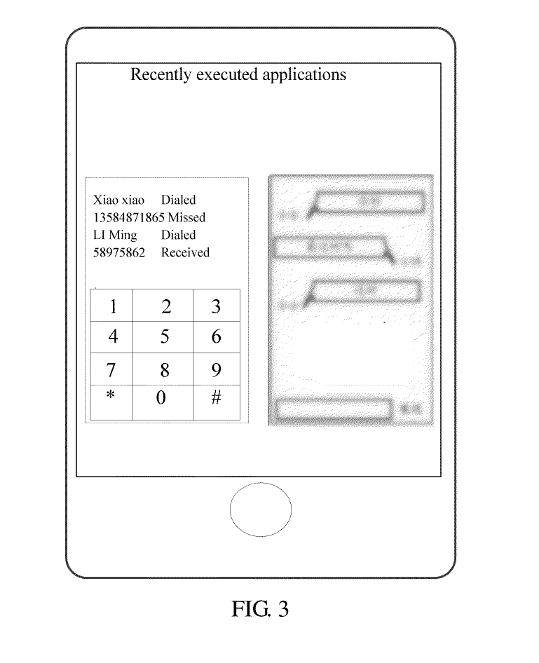

In the case of the foregoing setting, Ms. or Mr. Wang accesses an interface of the dialing application at a first instance of time and then presses directly the HOME key for long at the end of a talk, and then in response to the long press operation by Ms. or Mr. Wang on the HOME key, the smart phone detects the dialing application as a non-private application and stores the interface of the dialing application at the first instance of time, and when there is a jump from the dialing interface to an interface of a lastly executed application, then the interface of the lastly executed application includes at least the interface of the dialing application at the first instance of time. At a second instance of time subsequent to the first instance of time, Ms. or Mr. Wang presses directly the HOME key during her or his access to the QQ application for a chat, and then in response to the long press operation by Ms. or Mr. Wang on the HOME key, a QQ chat interface at the second instance of time is stored, and the smart phone A detects the QQ application as a private application and then obscures the QQ chat interface at the second instance of time into an obscured QQ chat interface as illustrated in FIG. 3, and thus the interface of the dialing application at the first instance of time and the obscured QQ chat interface at the second instance of time are displayed in the interface the lastly executed application to thereby protect private data of the user.

Based upon the same inventive idea, in the invention, an embodiment of this application provides an electronic device, which can be particularly a smart phone, a tablet computer, a notebook computer, etc., and which is capable of executing a first application.

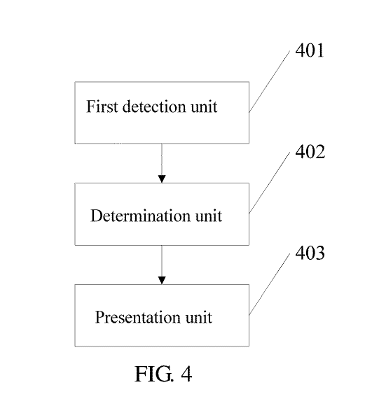

As illustrated in FIG. 4, the electronic device includes the following units:

A first detection unit 401 is configured to detect at an instance of time T1 whether there is a first predetermined operation, where the first predetermined operation is configured to control the electronic device to present a second interface for displaying a set of second applications satisfying a predetermined condition;

A determination unit 402 is configured to judge whether the set of second applications includes the first application; and

A presentation unit 403 is configured, when it is determined that the set of second applications includes the first application, to display the first application via a third interface in the second interface, where the difference between the third interface and a first interface is greater than or equal to a first threshold so that a user can not identify display contents of the first interface via the third interface, and the first interface is a display interface of the first application at the instance of time T1.

Furthermore, in a particular implementation, the first detection unit 401 further includes:

A press detection sub-unit is configured to detect whether there is a press operation pressing the “HOME” key for more than a predetermined length of time.

Furthermore in a particular implementation, the electronic device further includes:

A second detection unit is configured to detect a setting operation by the user; and

A setting unit is configured to set the first application as a private application in response to the setting operation so that a list of private applications includes the first application.

Furthermore in a particular implementation, when the third interface is a first application icon corresponding to the first application, the presentation unit 403 further includes:

An obtainment sub-unit is configured to obtain the first application icon; and

A first display sub-unit is configured to display the first application icon in the second interface to display the first application.

Furthermore, in a particular implementation, the presentation unit 403 further includes:

An image processing sub-unit is configured to perform image processing in a predetermined form on the first interface to form an identification interface via which the user can not view the display contents; and

A second display sub-unit is configured to present the identification interface in the second interface to display the first application.

Furthermore, in a particular implementation, the image processing sub-unit of the presentation unit is further configured:

To obscure the first interface to obscure the display contents; or

To add an overlying layer on the first interface to cover the display contents.

The electronic device according to this embodiment and the foregoing information processing method relate to two aspects based upon the same inventive idea, and the implementation of the method has been detailed above, so those skilled in the art can clearly appreciate the structure and implementation of the electronic device according to this embodiment in light of the foregoing description, and a repeated description thereof will be omitted here for conciseness of the description.

The foregoing technical solutions according to the embodiments of the invention have at least the following technical effects or advantages:

1. Upon detection of a first predetermined operation configured to control the electronic device to present a second interface, it is determined whether the set of second applications includes a first application, where the second interface is configured to display the set of second applications satisfying a predetermined condition; and when the set of second applications includes the first application, the first application is displayed via a third interface in the second interface, where the difference between the third interface and a first interface is greater than or equal to a first threshold, and with such a technical solution, the first application can be displayed via the third interface to thereby prevent the first interface at the instance of time T1 from being revealed so that a user can not identify display contents of the first interface via the third interface, thus addressing the technical problem in the convention of poor information confidentiality and further achieving a technical effect of preventing a last access status of an application from being revealed and thus improving information confidentiality.

2. Furthermore a setting operation by the user is detected before it is detected at the instance of time T1 whether there is a first predetermined operation; and in response to the setting operation, the first application is set as a private application so that a list of private applications includes the first application, and with such a technical solution, the application for which privacy needs to be protected can be displayed via the third interface, and an application for which no privacy needs to be protected can be displayed via the first interface, thereby achieving a technical effect of controlling flexibly the number and types of applications for which it is to be determined whether to output last access statuses.

3. Furthermore, the first application, for example, the first application icon corresponding to the first application, can be displayed via the third interface with a difference thereof from the first interface being above the first threshold, or the first interface can be image-processed and then output, so the user can not view the last access status of the first application, thereby achieving convenient and rapid protection of private data.

Although the preferred embodiments of the invention have been described, those skilled in the art benefiting from the underlying inventive concept can make additional modifications and variations to these embodiments. Therefore, the appended claims are intended to be construed as encompassing the preferred embodiments and all the modifications and variations coming into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. An information processing method, applicable to an electronic device capable of executing a first application, the method comprising:
detecting at an instance of time T1 whether there is a first predetermined operation, wherein the first predetermined operation is configured to control the electronic device to present a second interface for displaying a set of second applications satisfying a predetermined condition;
determining whether the set of second applications includes the first application; and
if it is determined that the set of second applications includes the first application, displaying the first application via a third interface in the second interface, wherein the difference between the third interface and a first interface is greater than or equal to a first threshold so that a user can not identify display contents of the first interface via the third interface, and the first interface is a display interface of the first application at the instance of time T1.

2. The method according to claim 1, wherein detecting whether there is a first predetermined operation further comprises:
detecting whether there is a press operation pressing the “HOME” key for more than a predetermined length of time.

3. The method according to claim 1, wherein the set of second applications comprises:
a set of applications operating in the electronic device; or
a set of applications which have been executed by the electronic device in a recent period of time of a predetermined length of time.

4. The method according to claim 1, wherein before the detecting at an instance of time T1 whether there is a first predetermined operation, the method further comprises:
detecting a setting operation by the user; and
setting the first application as a private application in response to the setting operation so that a list of private applications includes the first application

5. The method according to claim 4, wherein when the third interface is a first application icon corresponding to the first application, displaying the first application via the third interface in the second interface further comprises:
obtaining the first application icon; and
displaying the first application icon in the second interface to display the first application.

6. The method according to claim 4, wherein displaying the first application via the third interface in the second interface further comprises:
performing image processing in a predetermined form on the first interface to form an identification interface via which the user can not view the display contents; and
presenting the identification interface in the second interface to display the first application.

7. The method according to claim 6, wherein performing image processing in a predetermined form on the first interface further comprises:
obscuring the first interface to obscure the display contents; or
adding an overlying layer on the first interface to cover the display contents.

8. An electronic device capable of executing a first application, the electronic device comprising:
a first detection unit configured to detect at an instance of time T1 whether there is a first predetermined operation, wherein the first predetermined operation is configured to control the electronic device to present a second interface for displaying a set of second applications satisfying a predetermined condition;
a determination unit configured to judge whether the set of second applications includes the first application; and
a presentation unit configured, when it is determined that the set of second applications includes the first application, to display the first application via a third interface in the second interface, wherein the difference between the third interface and a first interface is greater than or equal to a first threshold so that a user can not identify display contents of the first interface via the third interface, and the first interface is a display interface of the first application at the instance of time T1.

9. The electronic device according to claim 8, wherein the first detection unit further comprises:
a press detection sub-unit configured to detect whether there is a press operation pressing the “HOME” key for more than a predetermined length of time.

10. The electronic device according to claim 8, wherein the electronic device further comprises:
a second detection unit is configured to detect a setting operation by the user; and
a setting unit configured to set the first application as a private application in response to the setting operation so that a list of private applications includes the first application.

11. The electronic device according to claim 10, wherein when the third interface is a first application icon corresponding to the first application, the presentation unit further comprises:
an obtainment sub-unit configured to obtain the first application icon; and
a first display sub-unit configured to display the first application icon in the second interface to display the first application.

12. The electronic device according to claim 10, wherein the presentation unit further comprises:
an image processing sub-unit configured to perform image processing in a predetermined form on the first interface to form an identification interface via which the user can not view the display contents; and
a second display sub-unit configured to present the identification interface in the second interface to display the first application.

13. The electronic device according to claim 12, wherein the image processing sub-unit is further configured:
to obscure the first interface to obscure the display contents; or
to add an overlying layer on the first interface to cover the display contents.
